(19) United States
(12) Patent Application Publication
(10) Pub. No.: US 2024/0151105 A1
(43) Pub. Date: May 9, 2024

(54) FOLDING LADDER WITH HANDRAIL

(71) Applicant: Zhijiang HUANG, Hangzhou (CN)

(72) Inventor: Zhijiang HUANG, Hangzhou (CN)

(73) Assignee: Yongkang Siyu Industry and Trade Co., Ltd., Yongkang (CN)

(21) Appl. No.: 18/500,296

(22) Filed: Nov. 2, 2023

(30) Foreign Application Priority Data
Nov. 3, 2022 (CN) 202222961371.9

(51) Int. Cl. E06C 1/20; E06C 7/08; E06C 7/18

(52) U.S. Cl. CPC E06C 1/20; E06C 7/081; E06C 7/182; E06C 7/183

(57) ABSTRACT

The present disclosure provides a folding ladder with a handrail. The folding ladder with a handrail includes a first frame component, a second frame component and a handrail frame component. A rotatable step board component is arranged on the first frame component. The second frame component is rotatably connected to the first frame component. The first end of the handrail frame component is rotatably connected to an upper end of the second frame component, and a second end of the handrail frame component is rotatably connected to one side the first frame component and close to a lower end of the first frame component. The folding ladder rotates between a first position and a second position.

### CROSS-REFERENCE TO RELATED APPLICATIONS

The application claims priority of Chinese patent application CN2022229613719, filed on Nov. 3, 2022, which is incorporated herein by reference in its entireties.

### TECHNICAL FIELD

The present disclosure relates to the technical field of folding ladders, and in particular, to a folding ladder with a handrail.

### BACKGROUND

Folding ladder is a commonly used tool in daily life. The existing folding ladder includes a front frame; front support rods on two sides of the front frame are respectively connected with rear support rods; positions, close to an upper end, of the rear support rods are hinged to the front support rods; folding step boards are arranged between the front support rods on the two sides of the front frame; and the rear support rods are rotated to be unfolded or folded.

For some folding ladders, to facilitate a user to get on to and get off from the ladder, a fixed handrail would be mounted on the front frame. However, a main body part of the ladder is folding, while the handrail is fixed and unfoldable. The presence of the fixed handrail affects the folding of the ladder. As a result, the ladder cannot achieve an ideal folded state after being folded, which affects the storage of the ladder.

For this purpose, the present disclosure provides a folding ladder with a handrail, which can effectively solve the above problems. The folding ladder has a simple structure. For storage, the handrail can be synchronously folded with the main body. For use, the handrail can be synchronously unfolded with the main body.

### SUMMARY

In order to overcome the shortcomings in the prior art, the present disclosure provides a folding ladder with a handrail. The folding ladder has a simple structure. For storage, the handrail can be synchronously folded with a main body. For use, the handrail can be synchronously unfolded with the main body.

The technical solution adopted by the present disclosure to solve the technical problem is as follows:

A folding ladder with a handrail, including:
a first frame component, wherein a rotatable step board component is arranged on the first frame component;
a second frame component, wherein the second frame component is rotatably connected to the first frame component;
a handrail frame component, wherein a first end of the handrail frame component is rotatably connected to an upper end of the second frame component, and a second end of the handrail frame component is rotatably connected to one side, close to a lower end of the first frame component, of the first frame component,
wherein the folding ladder rotates between a first position and a second position; at the first position, the first frame component and the handrail frame component both abut against the second frame component; the step board component is basically accommodated between an outer surface of the second frame component and an outer surface of the handrail frame component; at the second position, relative rotation between the first frame component and the second frame component is obstructed, and the first frame component and the second frame component are fixed and form a stable whole; an upper surface of the step board component is formed into a support plane; the handrail frame component is detached from the first frame component; and a space for allowing a hand of a user to pass is formed between the handrail frame component and the first frame component.

Preferably, the handrail frame component includes a grab bar and a handrail connecting rod; a first end of the grab bar is rotatably connected to a first end of the handrail connecting rod; a second end of the grab bar is rotatably connected to an upper end of the second frame component; a second end of the handrail connecting rod is rotatably connected to one side of the first frame component and close to the lower end of the first frame component.

Preferably, the upper end of the second frame component protrudes towards one side of the grab bar to form a first protrusion; the first end of the handrail connecting rod protrudes towards one side of the grab bar to form a second protrusion; the first protrusion is rotatably connected to the first end of the grab bar; and the second protrusion is rotatably connected to the first end of the grab bar.

Preferably, the step board component includes several step boards and a step board connecting rod; first ends of the step boards are rotatably connected to the first frame component, and second ends of the step boards are rotatably connected to the step board connecting rod; and when the folding ladder rotates between the first position and the second position, the step board connecting rod drives the step boards to rotate synchronously.

Preferably, the second frame component is provided with a limiting rod; at the first position, one of the step boards is butted to the limiting rod to hinder the relative rotation between the first frame component and the second frame component, and the first frame component and the second frame component are fixed and form a stable whole; and at the second position, one of the step boards is detached from the limiting rod to allow the relative rotation between the first frame component and the second frame component.

Preferably, one of the step boards is provided with a butting slot; at the first position, the limiting rod is clamped into the butting slot to hinder the relative rotation between the first frame component and the second frame component, and the first frame component and the second frame component are fixed and form a stable whole; and at the second position, the limiting rod is detached from the butting slot to allow the relative rotation between the first frame component and the second frame component.

Preferably, the first frame component includes two roughly parallel first support rods and a grip rod connecting upper ends of the two first support rods; and the two first support rods and the grip rod form the first frame component that is roughly “U”-shaped.

Preferably, the second frame component includes two roughly parallel second support rods and the limiting rod connecting the two second support rods; and the two second support rods are rotatably connected to the two first support rods, respectively.

Preferably, anti-slip pads are arranged at lower ends of the first support rods and lower ends of the second support rods.

Preferably, an upper surface of each step board is provided with an anti-slip surface.

Beneficial effects of the present disclosure are as follows: Through the arrangement of the structure described above, the first frame component and the second frame component are rotatably connected with each other; the first frame component is rotatably connected with the step board component; and the two ends of the handrail frame component are rotatably connected to the upper end of the second frame component and the first frame component, respectively. For use, the folding ladder is rotated towards the first position. At this time, an angle between the first frame component and the second frame component gradually decreases. Synchronously, the second frame component drives the handrail frame component to rotate until the first frame component and the second frame component abut against each other and the handrail frame component also abuts against the second frame component. The step board component is then rotated until it is roughly located between the outer surface of the second frame component and the outer surface of the handrail frame component. At this point, the folding ladder is in a storage state, which can effectively reduce a volume of a product. The handrail frame component rotates synchronously with the first frame component and the second frame component, without a need for separately disassembling or mounting of the handrail frame component, making it convenient to use. The folding ladder is rotated towards the second position. At this time, the angle between the first frame component and the second frame component gradually increases. Synchronously, the second frame component drives the handrail frame component to rotate until the angle between the first frame component and the second frame component is obstructed, and the first frame component and the second frame component are fixed to form a whole. In this case, the folding ladder is in a use state. Synchronously, the handrail frame component gradually moves away from the first frame component. The space for allowing the hand of the user to pass is formed between the handrail frame component and the first frame component, making it convenient for the user to grasp the handrail. The handrail frame component is rotatably connected to the first frame component and the second frame component through a rotating center, without a need for removing the handrail, making it convenient to use. Moreover, the handrail frame component can rotate synchronously with the first frame component and the second frame component and can be switched between the storage state and the use state, so as to effectively improve the user experience.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of an overall structure in one angle of a second position of a folding ladder according to the present disclosure;

FIG. 2 is a schematic diagram of an overall structure in another angle of a second position of a folding ladder according to the present disclosure;

FIG. 3 is a side view of a second position of a folding ladder according to the present disclosure;

FIG. 4 is a top view of a first position of a folding ladder according to the present disclosure;

FIG. 5 is a schematic diagram of an overall structure in one angle of a first position of a folding ladder according to the present disclosure;

FIG. 6 is a schematic diagram of an overall structure in another angle of a first position of a folding ladder according to the present disclosure; and

FIG. 7 is a side view of a first position of a folding ladder according to the present disclosure.

### DETAILED DESCRIPTION OF THE EMBODIMENTS

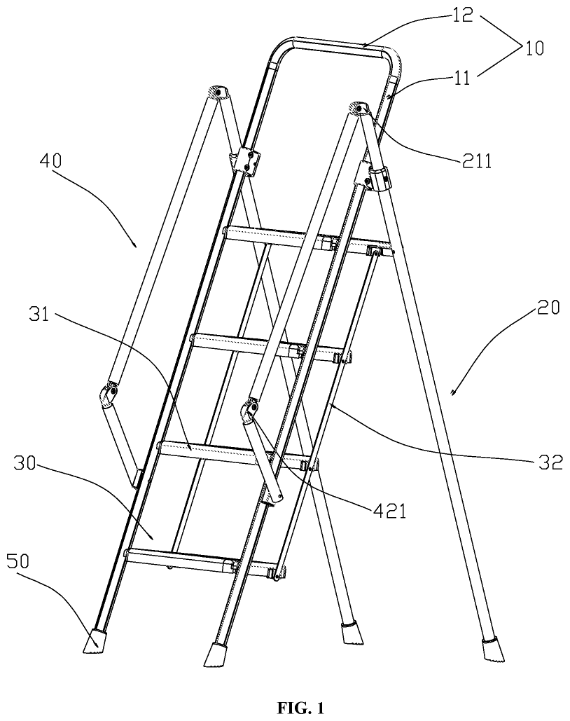

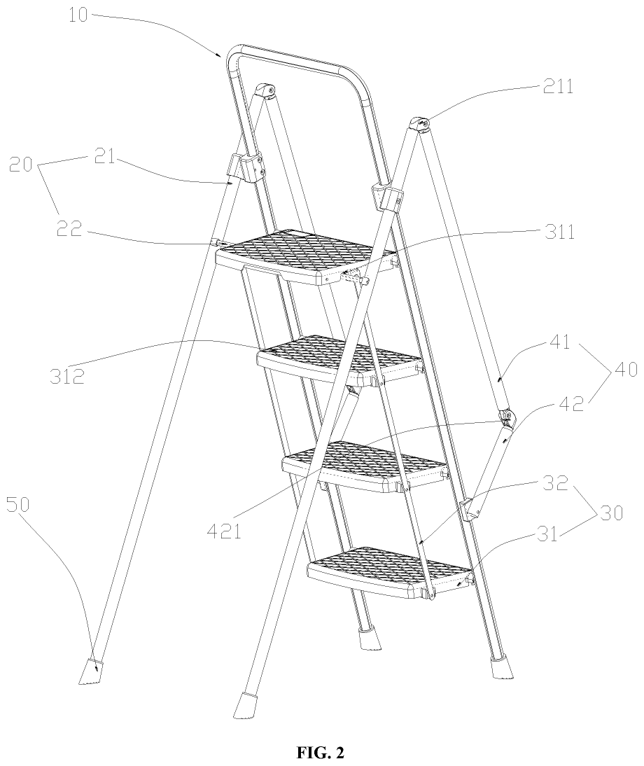

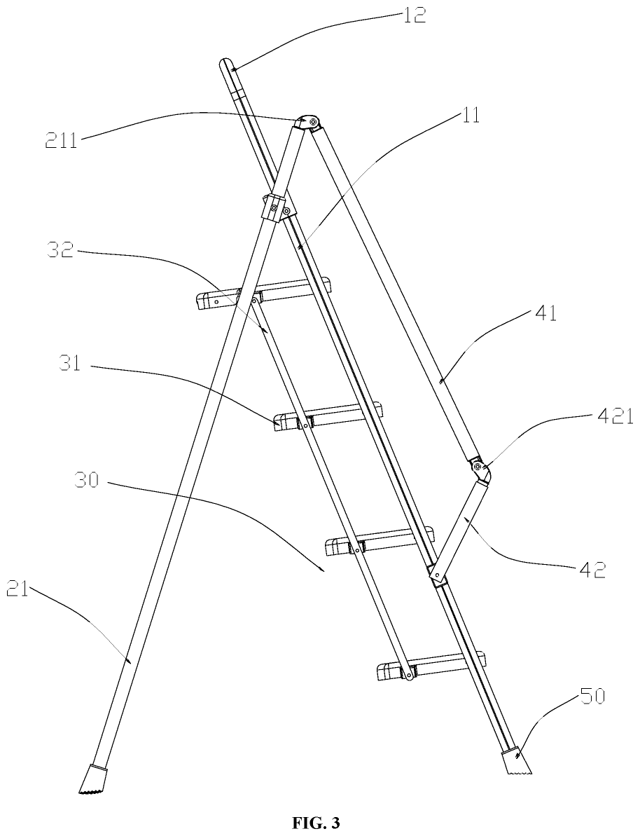

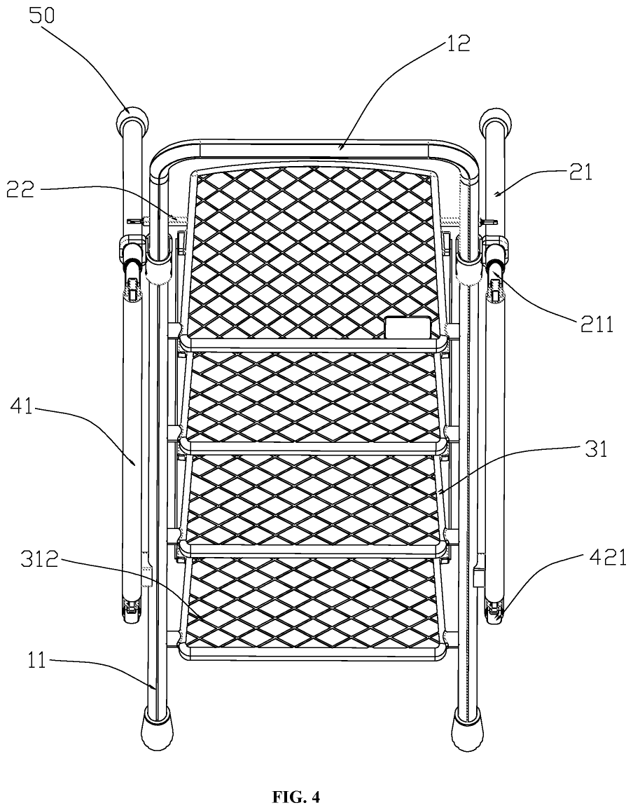

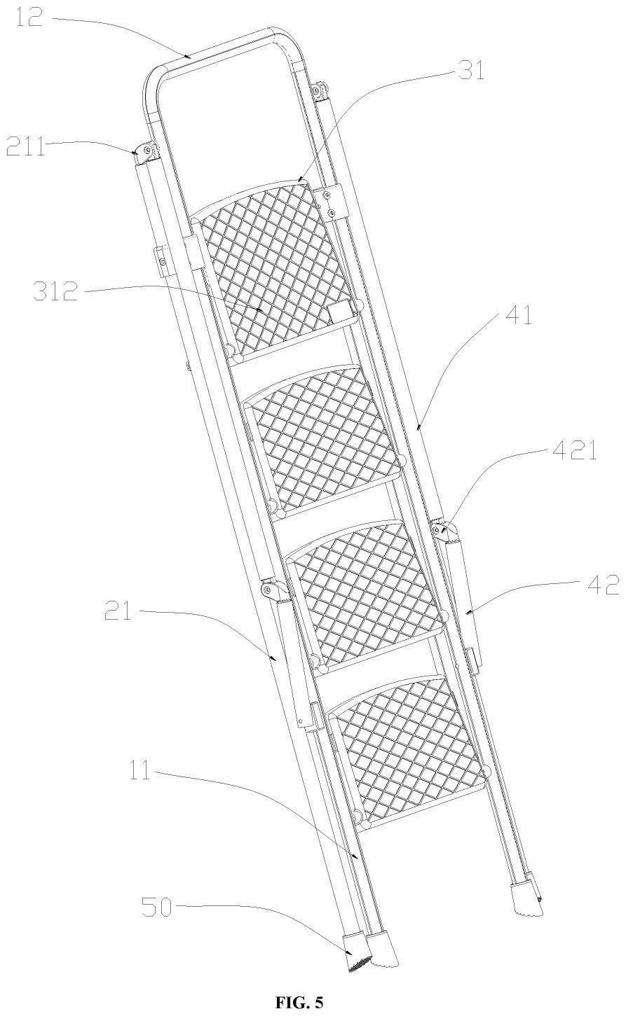

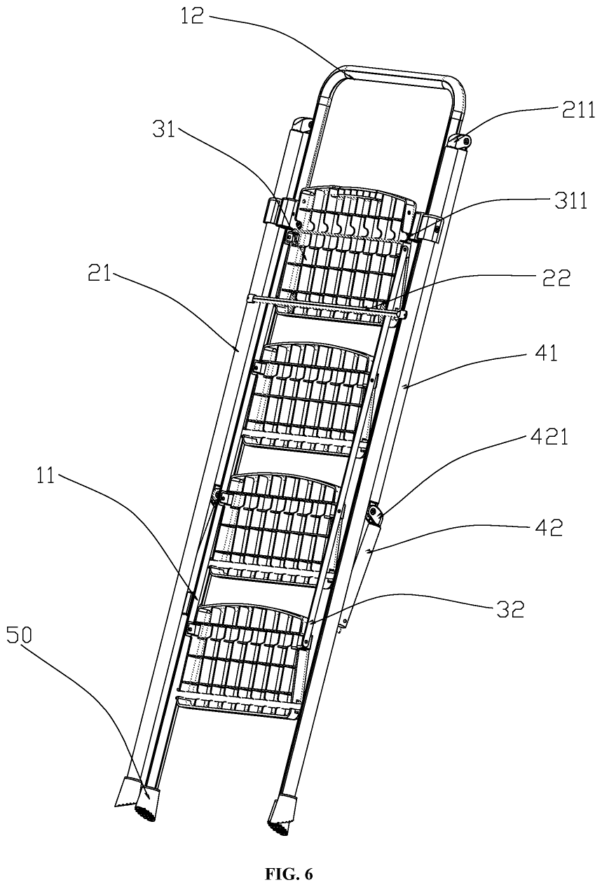

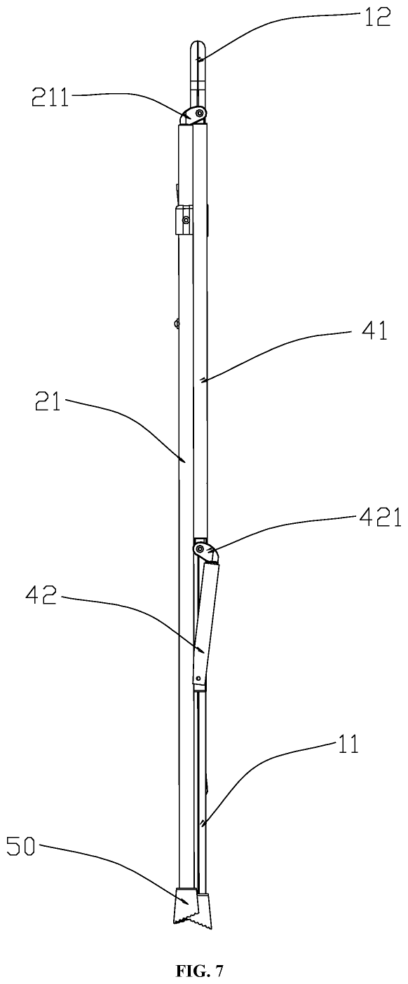

Referring to FIG. 1 to FIG. 7, a folding ladder with a handrail includes:
a first frame component 10, wherein a rotatable step board component 30 is arranged on the first frame component 10;
a second frame component 20, wherein the second frame component 20 is rotatably connected to the first frame component 10;
a handrail frame component 40, wherein a first end of the handrail frame component 40 is rotatably connected to an upper end of the second frame component 20, and a second end of the handrail frame component 40 is rotatably connected to one side of the first frame component 10 and close to a lower end of the first frame component 10. The folding ladder can rotate between a first position and a second position; at the first position, the first frame component 10 and the handrail frame component 40 both abut against the second frame component 20; the step board component 30 is basically accommodated between an outer surface of the second frame component 20 and an outer surface of the handrail frame component 40; at the second position, relative rotation between the first frame component 10 and the second frame component 20 is obstructed, and the first frame component and the second frame component are fixed and form a stable whole; an upper surface of the step board component 30 is formed into a support plane; the handrail frame component 40 is detached from the first frame component 10; and a space for allowing a hand of a user to pass is formed between the handrail frame component 40 and the first frame component 10.

Through the arrangement of the structure described above, the first frame component and the second frame component are rotatably connected with each other; the first frame component is rotatably connected with the step board component; and the two ends of the handrail frame component are rotatably connected to the upper end of the second frame component and the first frame component, respectively. For use, the folding ladder is rotated towards the first position. At this time, an angle between the first frame component and the second frame component gradually decreases. Synchronously, the second frame component drives the handrail frame component to rotate until the first frame component and the second frame component abut against each other and the handrail frame component also abuts against the second frame component. The step board component is then rotated until it is roughly located between the outer surface of the second frame component and the outer surface of the handrail frame component. At this point, the folding ladder is in a storage state, which can effectively reduce a volume of a product. The handrail frame component rotates synchronously with the first frame component and the second frame component, without a need for separately disassembling or mounting of the handrail frame component, making it convenient to use. The folding ladder is rotated towards the second position. At this time, the angle between the first frame component and the second frame component gradually increases. Synchronously, the second frame component drives the handrail frame component to rotate until the angle between the first frame component and the second frame component is obstructed, and the first frame component and the second frame component are fixed to form a whole. In this case, the folding ladder is in a use state. Synchronously, the handrail frame component gradually moves away from the first frame component. The space for allowing the hand of the user to pass is formed between the handrail frame component and the first frame component, making it convenient for the user to grasp the handrail. The handrail frame component is rotatably connected to the first frame component and the second frame component through a rotating center, without a need for removing the handrail, making it convenient to use. Moreover, the handrail frame component can rotate synchronously with the first frame component and the second frame component and can be switched between the storage state and the use state, so as to effectively improve the user experience.

The first frame component, the second frame component, and the handrail frame component can be made of a metal material, preferably, an aluminum alloy material, which can ensure the strength of the product and reduce the weight of the product. While ensuring user safety, it is convenient for the user to move, transport, and store the product.

In this embodiment, the handrail frame component 40 includes a grab bar 41 and a handrail connecting rod 42; a first end of the grab bar 41 is rotatably connected to a first end of the handrail connecting rod 42; a second end of the grab bar 41 is rotatably connected to an upper end of the second frame component 20; a second end of the handrail connecting rod 42 is rotatably connected to one side, close to the lower end of the first frame component 10, of the first frame component 10. The first frame component, the second frame component, the grab bar, and the handrail connecting rod form a structure similar to a parallelogram. When the first frame component and the second frame component rotate relative to each other, the grab bar and the handrail connecting rod also rotate synchronously, which can conveniently achieve synchronous folding and unfolding of the handrail, and the user does not need to move the handrail frame component, which further facilitates use. Moreover, the parallelogram structure is stable in transmission, which effectively improves the stability of the product.

In this embodiment, the upper end of the second frame component 20 protrudes towards one side of the grab bar 41 to form a first protrusion 211; the first end of the handrail connecting rod 42 protrudes towards one side of the grab bar 41 to form a second protrusion 421; the first protrusion 211 is rotatably connected to the first end of the grab bar 41; and the second protrusion 421 is rotatably connected to the first end of the grab bar 41. Through the arrangement of the structure described above, as the first frame component, the second frame component, the grab bar, and the handrail connecting rod all have certain thicknesses, when the folding ladder is rotated to the first position, due to the arrangement of the first protrusion and the second protrusion, the first frame component, the grab bar, and the handrail connecting rod can be allowed to all abut against the second frame component, so as to prevent mutual compression due to the thicknesses. The folding ladder can be allowed to be stored in a state with the smallest volume. This facilitates use, and the appearance is also more beautiful.

In this embodiment, the step board component 30 includes several step boards 31 and a step board connecting rod 32; first ends of the step boards 31 are rotatably connected to the first frame component 10, and second ends of the step boards 31 are rotatably connected to the step board connecting rod 32; and when the folding ladder rotates between the first position and the second position, the step board connecting rod 32 drives the step boards 31 to rotate synchronously. Through the arrangement of the structure described above, a structure similar to a parallelogram is formed between two step boards, the step board connecting rod, and the first frame component. The user can move one step board or the first frame component to drive all the step boards and the step board connecting rod to rotate synchronously, so that it is convenient for the user to adjust an angle between the step boards and the first frame component to achieve convenient storage or use. Furthermore, the step board connecting rod can also fix and support the step boards, which further improves the stability of the product.

In this embodiment, the second frame component 20 is provided with a limiting rod 22; at the first position, one of the step boards 31 is butted to the limiting rod 22 to hinder the relative rotation between the first frame component 10 and the second frame component 20, and the first frame component 10 and the second frame component 20 are fixed and form a stable whole; and at the second position, one of the step boards 31 is detached from the limiting rod 22 to allow the relative rotation between the first frame component 10 and the second frame component 20. Through the arrangement of the structure described above, for use, one step board is butted to the limiting rod and is fixed. Then, the respective step boards are fixed through the step board connecting rod, so that the entire step board component can be fixed, making it convenient for the user to step on and use the step boards. For storage, the step board is detached from the limiting rod, so that the entire step board component can be stored by rotating the step boards or moving the step board connecting rod, making it convenient for use and structurally stable. Preferably, the step board that is butted to the limiting rod is usually the uppermost step board, which further facilitates user operations.

In this embodiment, one of the step boards 31 is provided with a butting slot 311; at the first position, the limiting rod 22 is clamped into the butting slot 311 to hinder the relative rotation between the first frame component 10 and the second frame component 20, and the first frame component 10 and the second frame component 20 are fixed and form a stable whole; and at the second position, the limiting rod 22 is detached from the butting slot 311 to allow the relative rotation between the first frame component 10 and the second frame component 20. Through the arrangement of the structure described above, the butting slot and the limiting rod are matched to achieve longitudinal supporting for the step board component and to prevent lateral displacement of the step board component, which further fixes the step board component and improves the stability of the product.

In this embodiment, the first frame component 10 includes two roughly parallel first support rods 11 and a grip rod 12 connecting upper ends of the two first support rods 11; and the two first support rods 11 and the grip rod 12 form the first frame component 10 that is roughly “U”-shaped. During use, the user can grip and lean against the grip rod when stepping on a step board at a higher position, further facilitating use. At the same time, the grip rod can also achieve the connection between two first support rods, further improving the stability of the product and facilitating use.

In this embodiment, the second frame component 20 includes two roughly parallel second support rods 21 and the limiting rod 22 connecting the two second support rods 21; and the two second support rods 21 are rotatably connected to the two first support rods 11, respectively. Through the arrangement of the structure described above, the two second support rods are respectively connected to the two first support rods, which is convenient for connection and achieves a stable structure.

In this embodiment, anti-slip pads 50 are arranged at lower ends of the first support rods 11 and lower ends of the second support rods 21. Through the arrangement of the structure described above, the anti-slip pads are arranged at the lower ends of the first support rods and the lower ends of the second support rods, which can prevent the first support rods and the second support rods from sliding on the support plane and improve the stability of the product.

In this embodiment, an upper surface of each step board 31 is provided with an anti-slip surface 312. The anti-slip surfaces are arranged on the upper surfaces of the step boards, which can increase a friction force when the user steps on the step boards, ensuring the use safety of the user. Preferably, each anti-slip surface can be a surface with a plurality of bulges or recesses, or can be a surface with anti-slip lines, such as a grid-like anti-slip lines. A plurality of reinforcing ribs are also arranged on lower surfaces of the step boards, which can effectively improve the strength of the product and ensure the stability and safety of the product.

The folding ladder further includes a hinge seat. The first frame component and the second frame component are both connected to the hinge seat to achieve the relative rotation between the first frame component and the second frame component.

As described above, one or more embodiments are provided in conjunction with the detailed description, The specific implementation of the present disclosure is not confirmed to be limited to that the description is similar to or similar to the method, the structure and the like of the present disclosure, or a plurality of technical deductions or substitutions are made on the premise of the conception of the present disclosure to be regarded as the protection of the present disclosure.

What is claimed is:

1. A folding ladder with a handrail, comprising:
a first frame component, wherein a rotatable step board component is arranged on the first frame component;
a second frame component, wherein the second frame component is rotatably connected to the first frame component;
a handrail frame component, wherein a first end of the handrail frame component is rotatably connected to an upper end of the second frame component, and a second end of the handrail frame component is rotatably connected to one side of the first frame component and close to a lower end of the first frame component, wherein the folding ladder rotates between a first position and a second position; at the first position, the first frame component and the handrail frame component both abut against the second frame component; the step board component is basically accommodated between an outer surface of the second frame component and an outer surface of the handrail frame component; at the second position, relative rotation between the first frame component and the second frame component is obstructed, and the first frame component and the second frame component are fixed and form a stable whole; an upper surface of the step board component is formed into a support plane; the handrail frame component is detached from the first frame component; and a space for allowing a hand of a user to pass is formed between the handrail frame component and the first frame component.

2. The folding ladder with the handrail according to claim 1, wherein the handrail frame component comprises a grab bar and a handrail connecting rod; a first end of the grab bar is rotatably connected to a first end of the handrail connecting rod; a second end of the grab bar is rotatably connected to an upper end of the second frame component; a second end of the handrail connecting rod is rotatably connected to one side of the first frame component, close to the lower end of the first frame component.

3. The folding ladder with the handrail according to claim 2, wherein the upper end of the second frame component protrudes towards one side of the grab bar to form a first protrusion; the first end of the handrail connecting rod protrudes towards one side of the grab bar to form a second protrusion; the first protrusion is rotatably connected to the first end of the grab bar; and the second protrusion is rotatably connected to the first end of the grab bar.

4. The folding ladder with the handrail according to claim 1, wherein the step board component comprises several step boards and a step board connecting rod; first ends of the step boards are rotatably connected to the first frame component, and second ends of the step boards are rotatably connected to the step board connecting rod; and when the folding ladder rotates between the first position and the second position, the step board connecting rod drives the step boards to rotate synchronously.

5. The folding ladder with the handrail according to claim 4, wherein the second frame component is provided with a limiting rod; at the first position, one of the step boards is butted to the limiting rod to hinder the relative rotation between the first frame component and the second frame component, and the first frame component and the second frame component are fixed and form a stable whole; and at the second position, one of the step boards is detached from the limiting rod to allow the relative rotation between the first frame component and the second frame component.

6. The folding ladder with the handrail according to claim 5, wherein one of the step boards is provided with a butting slot; at the first position, the limiting rod is clamped into the butting slot to hinder the relative rotation between the first frame component and the second frame component, and the first frame component and the second frame component are fixed and form a stable whole; and at the second position, the limiting rod is detached from the butting slot to allow the relative rotation between the first frame component and the second frame component.

7. The folding ladder with the handrail according to claim 5, wherein the first frame component comprises two roughly parallel first support rods and a grip rod connecting upper ends of the two first support rods; and the two first support rods and the grip rod form the first frame component that is roughly “U”-shaped.

8. The folding ladder with the handrail according to claim 7, wherein the second frame component comprises two roughly parallel second support rods and the limiting rod connecting the two second support rods; and the two second support rods are rotatably connected to the two first support rods, respectively.

9. The folding ladder with the handrail according to claim 8, wherein anti-slip pads are arranged at lower ends of the first support rods and lower ends of the second support rods.

10. The folding ladder with the handrail according to claim 4, wherein an upper surface of each step board is provided with an anti-slip surface.
